(19) United States
(12) Patent Application Publication
(10) Pub. No.: US 2013/0216864 A1
(43) Pub. Date: Aug. 22, 2013

(54) MAGNETIC RECORDING MEDIUM AND METHOD OF MANUFACTURING THE SAME

(71) Applicants: Kazutaka Takizawa, Fuchu-shi (JP); Akira Watanabe, Kawasaki-shi (JP); Kaori Kimura, Yokohama-shi (JP); Takeshi Iwasaki, Inagi-shi (JP)

(72) Inventors: Kazutaka Takizawa, Fuchu-shi (JP); Akira Watanabe, Kawasaki-shi (JP); Kaori Kimura, Yokohama-shi (JP); Takeshi Iwasaki, Inagi-shi (JP)

(73) Assignee: KABUSHIKI KAISHA TOSHIBA, Tokyo (JP)

(21) Appl. No.: 13/597,608

(22) Filed: Aug. 29, 2012

(30) Foreign Application Priority Data
Feb. 17, 2012 (JP) 2012-033315

(51) Int. Cl. G11B 5/84; G11B 5/62

(52) U.S. Cl. 428/834; 427/130

(57) ABSTRACT

According to at least one embodiment, a release layer, a first mask layer containing a first metal material, an antidiffusion layer containing an oxide or nitride of the first metal material, and a second mask layer containing a second metal material are formed on a magnetic recording layer, a resist layer is formed on the second mask layer, and projections pattern is formed in the resist layer and sequentially transferred to the second mask layer, antidiffusion layer, first mask layer, release layer, and magnetic recording layer. After that, the release layer is removed.

### CROSS-REFERENCE TO RELATED APPLICATIONS

This application is based upon and claims the benefit of priority from Japanese Patent Application No. 2012-033315, filed Feb. 17, 2012, the entire contents of which are incorporated herein by reference.

### FIELD

Embodiments described herein relate generally to a magnetic recording medium and a method of manufacturing the same.

### BACKGROUND

Recently, the amount of information to be processed by information communication apparatuses is constantly increasing, and strong demands have arisen for implementing a large-capacity recording device. As hard disk drive (HDD) techniques, the development of various techniques such as perpendicular magnetic recording has been advanced to increase the recording density. In addition, a discrete track medium and bit patterned medium have been proposed as media capable of increasing both the recording density and thermal decay resistance, and it is of urgent necessity to develop the manufacturing techniques of these media.

To record one-bit information in one cell as in the bit patterned medium, it is only necessary to magnetically isolate individual cells. In many cases, therefore, magnetic dot portions and nonmagnetic dot portions are formed in the same plane based on a micropatterning technique. Alternatively, the magnetism of a recording medium is selectively deactivated by injecting different types of ionized elements. In either case, a general approach is to use micropatterns.

More specifically, a magnetic recording layer formed on a substrate is patterned by applying a semiconductor manufacturing technique so as to isolate a magnetic region and nonmagnetic region. A patterning mask for transferring fine projections pattern is formed on the magnetic recording layer, and a three-dimensional structure is formed on the patterning mask and transferred to the magnetic recording layer, thereby obtaining a magnetic recording medium in which projections pattern is isolated.

The three-dimensional structure is formed on the mask pattern by using a versatile resist material of semiconductor fabrication. Examples are a method of obtaining desired patterns by selectively modifying the resist material by irradiation with an energy line, a method of patterning a self-organized film formed by arranging patterns having different chemical properties in the resist film, and a method of performing patterning by physically pressing a three-dimensional template. There is still another method by which after a three-dimensional structure is formed on mask patterns, ions irradiated with high energy are implanted into a magnetic recording layer to selectively deactivate the magnetism of the patterns, thereby obtaining a magnetically isolated medium.

The projections pattern formed on the resist film is transferred to the lower mask layer by etching. The mask layer is made of a nonmetal such as C, or a metal material such as Al, and Si. In an actual process, it is desirable to process projections pattern with high precision and high etching selectivity. Therefore, a general method is to form a mask layer by stacking different metal materials. When stacking different types of metals, a metal compound is formed in the interface between the layers. This metal compound contains a metal material that makes etching for ensuring the selectivity difficult, and hence deteriorates the transfer properties of the projections pattern. The metal compound may also increase a so-called, in-plane variation by which the difference between projections and recesses varies from one place to another during etching.

As a metal mask transfer process for the bit patterned medium, a technique of performing processing by using a mask material formed by stacking materials such as C and Si has been disclosed. In this technique, it is necessary to add a different etching step in order to remove the metal compound in the interface between the layers as described above. However, it is in many cases difficult to acquire a processing margin capable of removing the metal compound. In addition, a thick processing mask must be formed because the etching time prolongs in order to remove the metal compound.

### BRIEF DESCRIPTION OF THE DRAWINGS

FIG. 1A is an exemplary view showing an example of a manufacturing step of a magnetic recording medium according to the first embodiment;

FIG. 1B is an exemplary view showing an example of a manufacturing step of the magnetic recording medium according to the first embodiment;

FIG. 1C is an exemplary view showing an example of a manufacturing step of the magnetic recording medium according to the first embodiment;

FIG. 1D is an exemplary view showing an example of a manufacturing step of the magnetic recording medium according to the first embodiment;

FIG. 1E is an exemplary view showing an example of a manufacturing step of the magnetic recording medium according to the first embodiment;

FIG. 1F is an exemplary view showing an example of a manufacturing step of the magnetic recording medium according to the first embodiment;

FIG. 1G is an exemplary view showing an example of a manufacturing step of the magnetic recording medium according to the first embodiment;

FIG. 1H is an exemplary view showing an example of a manufacturing step of the magnetic recording medium according to the first embodiment;

FIG. 1I is an exemplary view showing an example of a manufacturing step of the magnetic recording medium according to the first embodiment;

FIG. 2A is an exemplary view showing an example of a manufacturing step of a magnetic recording medium according to the second embodiment;

FIG. 2B is an exemplary view showing an example of a manufacturing step of the magnetic recording medium according to the second embodiment;

FIG. 2C is an exemplary view showing an example of a manufacturing step of the magnetic recording medium according to the second embodiment;

FIG. 2D is an exemplary view showing an example of a manufacturing step of the magnetic recording medium according to the second embodiment;

FIG. 2E is an exemplary view showing an example of a manufacturing step of the magnetic recording medium according to the second embodiment;

FIG. 2F is an exemplary view showing an example of a manufacturing step of the magnetic recording medium according to the second embodiment;

FIG. 2G is an exemplary view showing an example of a manufacturing step of the magnetic recording medium according to the second embodiment;

FIG. 2H is an exemplary view showing an example of a manufacturing step of the magnetic recording medium according to the second embodiment;

FIG. 2I is an exemplary view showing an example of a manufacturing step of the magnetic recording medium according to the second embodiment;

FIG. 2J is an exemplary view showing an example of a manufacturing step of the magnetic recording medium according to the second embodiment;

FIG. 2K is an exemplary view showing an example of a manufacturing step of the magnetic recording medium according to the second embodiment;

FIG. 3A is an exemplary view showing another example of a manufacturing step of a magnetic recording medium according to the first embodiment;

FIG. 3B is an exemplary view showing another example of a manufacturing step of the magnetic recording medium according to the first embodiment;

FIG. 3C is an exemplary view showing another example of a manufacturing step of the magnetic recording medium according to the first embodiment;

FIG. 3D is an exemplary view showing another example of a manufacturing step of the magnetic recording medium according to the first embodiment;

FIG. 3E is an exemplary view showing another example of a manufacturing step of the magnetic recording medium according to the first embodiment;

FIG. 3F is an exemplary view showing another example of a manufacturing step of the magnetic recording medium according to the first embodiment;

FIG. 3G is an exemplary view showing another example of a manufacturing step of the magnetic recording medium according to the first embodiment;

FIG. 3H is an exemplary view showing another example of a manufacturing step of the magnetic recording medium according to the first embodiment;

FIG. 3I is an exemplary view showing another example of a manufacturing step of the magnetic recording medium according to the first embodiment;

FIG. 4 is a graph showing the ion milling rates of a Ta₂O₅ film and Ta film; and

FIG. 5 is an exemplary view showing examples of recording bit patterns.

### DETAILED DESCRIPTION

Embodiments will be explained in more detail below with reference to the accompanying drawings.

A magnetic recording medium manufacturing method according to an embodiment is divided into two embodiments.

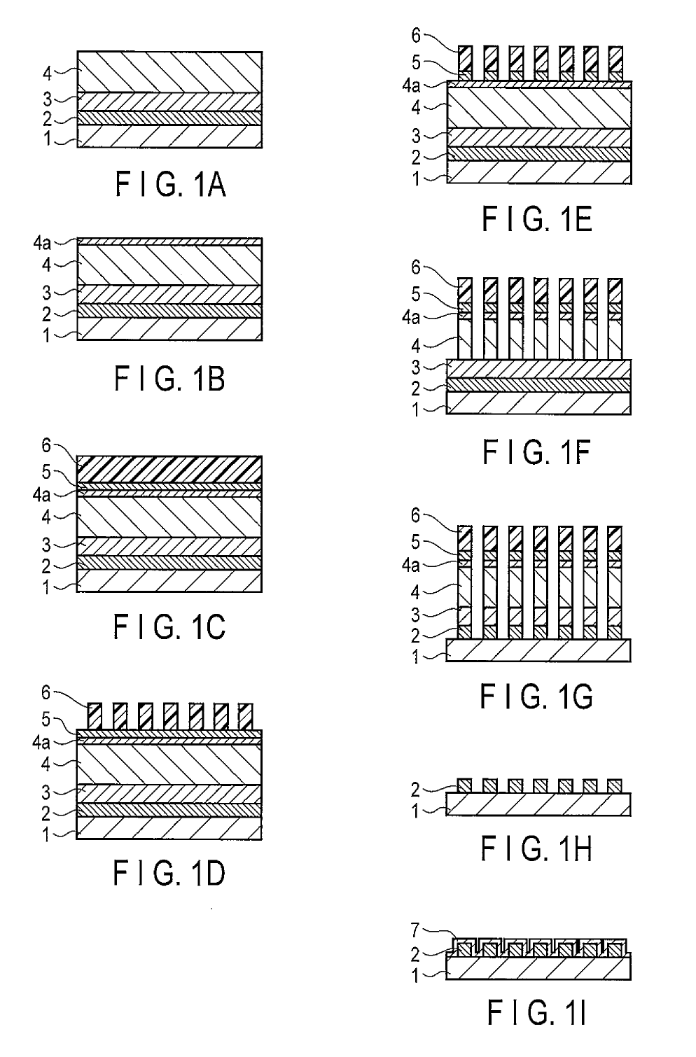

FIGS. 1A, 1B, 1C, 1D, 1E, 1F, 1G, 1H, and 1I are exemplary views showing examples of manufacturing steps of a magnetic recording medium according to the first embodiment.

A method of manufacturing the magnetic recording medium according to the first embodiment includes a step (FIG. 1A) of forming a magnetic recording layer 2 on a substrate 1, a step (FIG. 1A) of forming a release layer 3 on the magnetic recording layer 2, a step (FIG. 1A) of forming a first mask layer 4 containing a first metal material on the release layer 3, a step (FIG. 1B) of forming an antidiffusion layer 4a containing an oxide or nitride of the first metal material by modifying the surface layer of the first mask layer 4 by exposing it to an oxygen or nitrogen ambient, a step (FIG. 1C) of forming a second mask layer 5 containing a second metal material on the antidiffusion layer 4a, a step (FIG. 1C) of forming a resist layer 6 on the second mask layer 5, a step (FIG. 1D) of forming projections pattern in the resist layer 6, a step (FIG. 1E) of transferring the projections pattern to the second mask layer 5, a step (FIG. 1F) of transferring the projections pattern to the antidiffusion layer 4a, a step (FIG. 1F) of transferring the projections pattern to the first mask layer 4, a step (FIG. 1G) of transferring the projections pattern to the release layer 3, a step (FIG. 1G) of transferring the projections pattern to the magnetic recording layer 2, a step (FIG. 1H) of removing the release layer 3, and also removing the layers 4, 4a, 5, and 6 remaining on the magnetic recording layer 2, and a step (FIG. 1I) of forming a protective film 7 on the magnetic recording layer 2 after the release layer 3 is removed.

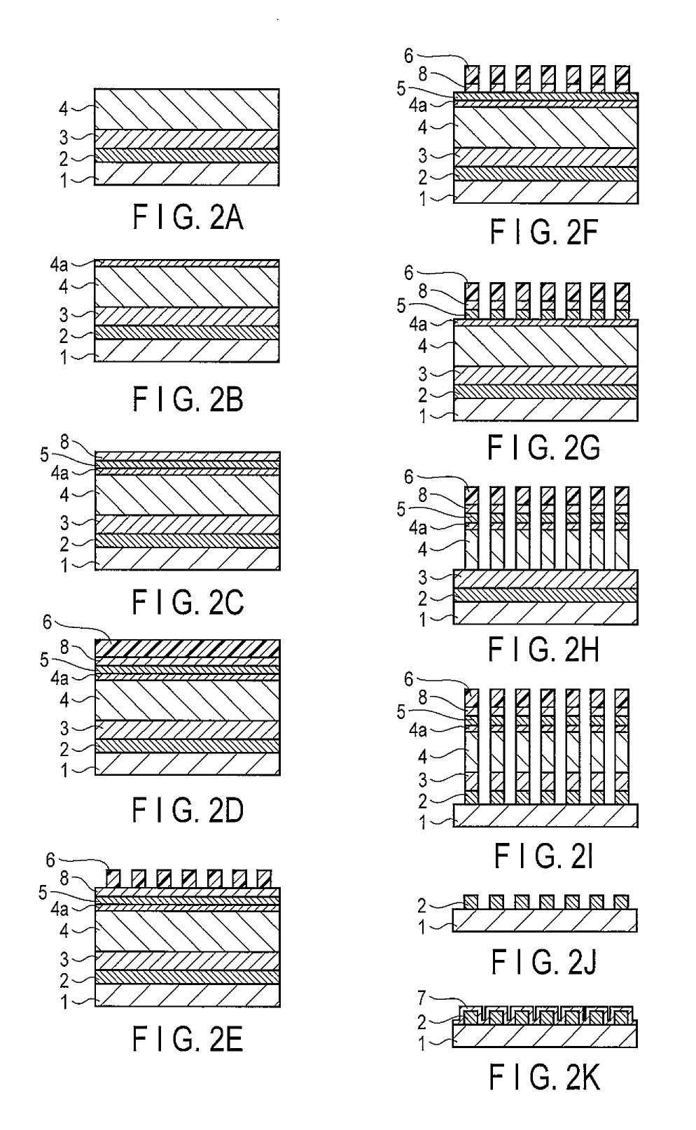

FIGS. 2A, 2B, 2C, 2D, 2E, 2F, 2G, 2H, 2I, 2J, and 2K are exemplary views showing examples of manufacturing steps of a magnetic recording medium according to the second embodiment.

As shown in FIGS. 2A, 2B, 2C, 2D, 2E, 2F, 2G, 2H, 2I, 2J, and 2K, a method of manufacturing the magnetic recording medium according to the second embodiment is the same as the method according to the first embodiment shown in FIGS. 1A, 1B, 1C, 1D, 1E, 1F, 1G, 1H, and 1I except that this method includes forming (FIG. 2D) a projections pattern transfer layer 8 between a second mask layer 5 and resist layer 6 by a step (FIG. 2C) of forming the projections pattern transfer layer 8 before the resist layer 6 is formed on the second mask layer 5, and further includes a step (FIG. 2F) of transferring the projections pattern of the resist layer 6 to the projections pattern transfer layer 8.

In the first and second embodiments, the first mask layer 4 is made of the first metal material or contains the first metal material.

The first metal material is made of a first metal or its alloy.

The antidiffusion layer 4a is made of an oxide or nitride of the first metal material, or contains an oxide or nitride of the first metal material.

The antidiffusion layer 4a is formed by exposing the surface of the first mask layer to a gas ambient containing oxygen or nitrogen in a vacuum chamber.

The second mask layer 5 is made of a second metal material or contains the second metal material.

The second metal material is selected from the group consisting of a second metal different from the first metal material, and an alloy, oxide, nitride, and carbide of the second metal material.

Examples of a method of forming the projections pattern in the resist layer 6 are lithography using an energy line, nanoimprinting, and patterning using a self-organized film made of a block copolymer having at least two types of polymer chains. When using the self-organized film, a micro phase-separated structure is formed in the film, one type of a polymer phase is selectively removed, and the projections pattern is transferred by using the remaining polymer as a mask.

In the second embodiment, the transfer layer 8 can be selected from materials that can increase the etching selectivities to the resist layer 6 and second mask layer 5.

In the first and second embodiments, dissolution by dry etching or wet etching can be performed in the step of removing the release layer 3. It is possible to remove the release layer 3, and also remove the layers remaining on the release layer 3, e.g., the resist layer 6, second mask layer 5, antidiffusion layer 4a, and first mask layer 4 from the magnetic recording layer 2.

In the magnetic recording medium manufacturing methods according to the first and second embodiments, it is possible to decrease the etching rate and increase the processing margin of the magnetic recording layer by using the metal mask layers including the first mask layer 4 and second mask layer 5, when compared to a method using a carbon mask. In addition, since the antidiffusion layer 4a is formed between the first mask layer 4 and second mask layer 5, mutual diffusion of the first and second metal materials between the first mask layer 4 and second mask layer 5 is suppressed, and no metal compound layer that is difficult to etch is formed. This facilitates etching, and improves the pattern transfer properties.

Furthermore, although the film thickness variations of the metal mask layers produce a pattern projection-recess difference in the plane of the medium, the dependence of the pattern projection-recess difference on a position decreases because the antidiffusion layer compensates for the etching amount in the plane.

Since the antidiffusion layer 4a is formed by supplying a gas containing oxygen or nitrogen into a vacuum chamber, it is unnecessary to newly deposit any metal oxide layer or metal nitride layer, and this reduces the process cost and improves the manufacturing throughput. No dust is generated by the deposition of an oxide or the like, so the flatness of the medium improves. Also, the thickness of the first mask layer 4 for obtaining an etching resistance can be decreased by suppressing the formation of the antidiffusion layer 4a. That is, it is readily possible to, e.g., adjust the width by etching.

A magnetic recording medium according to an embodiment is formed by using the first or second magnetic recording medium manufacturing method.

### First Embodiment

### Magnetic Recording Layer Formation Step

First, a magnetic recording medium is obtained by forming a magnetic recording layer on a substrate.

Although the shape of the substrate is not limited at all, the substrate is normally circular and made of a hard material. Examples are a glass substrate, metal-containing substrate, carbon substrate, and ceramic substrate. To improve the pattern in-plane uniformity, the roughness of the substrate surface is desirably small. It is also possible to form a protective film such as an oxide film on the substrate surface as needed. As the glass substrate, it is possible to use amorphous glass such as soda lime glass or aluminosilicate glass, or crystallized glass such as lithium-based glass. Furthermore, a sintered substrate mainly containing alumina, aluminum nitride, or silicon nitride can be used as the ceramic substrate.

A magnetic recording layer including a perpendicular magnetic recording layer mainly containing cobalt is formed on the substrate.

A soft under layer (SUL) having a high magnetic permeability can be formed between the substrate and perpendicular magnetic recording layer. The soft under layer returns a recording magnetic field from a magnetic head for magnetizing the perpendicular magnetic recording layer, i.e., performs a part of the magnetic head function. The soft under layer can apply a sufficient steep perpendicular magnetic field to the magnetic field recording layer, thereby increasing the recording/reproduction efficiency. A material containing Fe, Ni, or Co can be used as the soft under layer. Among these materials, it is possible to use an amorphous material having none of magnetocrystalline anisotropy, a crystal defect, and a grain boundary, and showing a high soft magnetism. The soft amorphous material can reduce the noise of the recording medium. An example of the soft amorphous material is a Co alloy mainly containing Co and also containing at least one of Zr, Nb, Hf, Ti, and Ta, and it is possible to select, e.g., CoZr, CoZrNb, or CoZrTa.

In addition, a base layer for improving the adhesion of the soft under layer can be formed between the soft under layer and substrate. As the base layer material, it is possible to use, e.g., Ni, Ti, Ta, W, Cr, Pt, and alloys, oxides, and nitrides of these elements. For example, it is possible to use NiTa and NiCr. Note that the base layer can include a plurality of layers.

Furthermore, an interlayer made of a nonmagnetic metal material can be formed between the soft under layer and perpendicular magnetic recording layer. The interlayer has two functions: one is to interrupt the exchange coupling interaction between the soft under layer and perpendicular magnetic recording layer; and the other is to control the crystallinity of the perpendicular magnetic recording layer. The interlayer material can be selected from Ru, Pt, Pd, W, Ti, Ta, Cr, and Si, or alloys, oxides, and nitrides of these elements.

The perpendicular magnetic recording layer mainly contains Co, also contains at least Pt, and can further contain a metal oxide. In addition to Co and Pt, the layer can also contain one or more elements selected from B, Ta, Mo, Cu, Nd, W, Nb, Sm, Tb, and Ru. When these elements are contained, it is possible to promote downsizing of magnetic grains, and improve the crystallinity and alignment, thereby obtaining recording/reproduction characteristics and thermal decay characteristics for a high recording density. Practical examples of the material usable as the perpendicular magnetic recording layer are alloys such as a CoPt-based alloy, a CoCr-based alloy, a CoCrPt-based alloy, CoPtO, CoPtCrO, CoPtSi, CoPtCrSi, and CoCrSiO₂. The thickness of the perpendicular magnetic recording layer can be set to 5 nm or more in order to measure a reproduced output signal with high accuracy, and can be set to 40 nm or less in order to suppress the distortion of the signal intensity. If the thickness is smaller than 5 nm, the output signal is extremely low, and the noise component becomes dominant. On the other hand, if the thickness is larger than 40 nm, the output signal becomes excessive, and the signal waveform is distorted.

A protective layer can be formed on the perpendicular magnetic recording layer.

The protective layer has the effect of preventing corrosion and deterioration of the perpendicular magnetic recording layer, and also has the effect of preventing damage to the medium surface when a magnetic head comes in contact with the recording medium.

Examples of the protective layer material are materials containing C, Pd, SiO₂, and ZrO₂. Carbon can be classified into sp²-bonded carbon (graphite) and sp³-bonded carbon (diamond). Sp³-bonded carbon is superior in durability and corrosion resistance, and sp²-bonded carbon is superior in flatness. Carbon is normally deposited by sputtering using a graphite target, and amorphous carbon containing both sp²-bonded carbon and sp³-bonded carbon is deposited. Carbon in which the ratio of sp³-bonded carbon is high is called diamond-like carbon (DLC). DLC is superior in durability, corrosion resistance, and flatness, and usable as the protective layer of the magnetic recording layer.

Furthermore, a lubricating layer can be formed on the protective layer. Examples of a lubricant used in the lubricating layer are perfluoropolyether, alcohol fluoride, and fluorinated carboxylic acid. By the process described above, the perpendicular magnetic recording medium is formed on the substrate.

### Release Layer Formation Step

Subsequently, a release layer is formed on the magnetic recording layer.

The release layer is removed by dry etching and wet etching, and finally achieves a function of removing the mask material from the surface of the magnetic recording layer.

The release layer can be selected from the group consisting of various inorganic materials and polymeric materials.

The inorganic materials usable as the release layer can be selected from C and metals such as Mo, W, Zn, Co, Ge, Al, Cu, Au, Ni, and Cr. These inorganic materials can be removed by using an acid solution or alkali solution.

Examples of the polymeric materials usable as the release layer are a novolak resin as a versatile resist material, polystyrene, polymethylmethacrylate, methylstyrene, polyethyleneterephthalate, polyhydroxystyrene, polyvinylpyrrolidone, and polymethylcellulose. These resist materials can be removed by using an organic solvent or water. These materials may also be composite materials containing a metal in order to increase the etching resistance.

The release layer made of the metal material can be formed by physical vapor deposition (PVD) such as vacuum deposition, electron beam deposition, molecular beam deposition, ion beam deposition, ion plating, or sputtering, or chemical vapor deposition (CVD) using heat, light, or plasma. The release layer made of the polymeric material can be formed by, e.g., spin coating, spray coating, spin casting, dip coating, or an inkjet method.

The thickness of the release layer can appropriately be adjusted by changing parameters such as the process gas pressure, gas flow rate, substrate temperature, input power, ultimate vacuum degree, chamber ambient, and deposition time in PVD and CVD. When using the polymeric material, the thickness can appropriately be changed by parameters such as the concentration of a polymeric release layer precursor, and the rotational speed and coating time set during deposition. When transferring projections pattern, the thickness of the release layer can be adjusted in accordance with the pattern dimensions, so that removal is possible and the three-dimensional structure does not collapse.

### First Mask Layer Formation Step

A first mask layer for transferring projections pattern is formed on the release layer.

The first mask layer is made of a first metal material or mainly contains the first metal material.

The first mask layer functions as a main mask when processing the lower release layer and magnetic recording layer. As the first metal material, therefore, it is possible to use a material capable of increasing the physical or chemical etching selectivity to the magnetic recording layer material. Examples of the first metal material are a metal selected from Ta, Si, W, Ge, Hf, and Zr, and an alloy thereof.

Like the release layer, the first mask layer can be formed by physical vapor deposition or chemical vapor deposition.

The thickness of the first mask layer can be determined by taking account of the etching selectivities to the release layer and magnetic recording layer, and the projections pattern dimensions. When depositing the first mask layer, its thickness can be adjusted by changing parameters such as the process gas pressure, gas flow rate, substrate temperature, input power, ultimate vacuum degree, chamber ambient, and deposition time.

The transfer uniformity of projections pattern to be formed on the first mask layer largely depends on the surface roughness of the mask layer. Accordingly, since the dependence on the surface roughness of the first mask layer is large, the roughness can be reduced by using an amorphous material rather than a crystalline material.

### Antidiffusion Layer Formation Step

Subsequently, an antidiffusion layer is formed on the first mask layer.

The antidiffusion layer is formed near the surface of the first mask layer by exposing it to a gas ambient containing oxygen or nitrogen. The antidiffusion layer is made of an oxide or nitride of the main element forming the first mask layer.

The antidiffusion layer is formed on the surface of a sample by placing it in a vacuum vessel such as a sputtering chamber, and supplying a gas containing oxygen or nitrogen. In this case, the antidiffusion layer can be formed by returning the sample from a vacuum to the atmosphere, thereby exposing the sample to the atmosphere. Since, however, reloading of the sample prolongs the manufacturing time, the antidiffusion layer is desirably formed in a vacuum. Also, it is unnecessary to newly deposit any metal oxide layer or metal nitride layer as described previously, and this reduces the manufacturing cost.

The ambient in the chamber can be adjusted by changing the flow rate of a reactive gas, and it is possible to supply a reactive gas such as H, or an inert gas such as Ar. Furthermore, the thickness of the antidiffusion layer can be changed by changing the exposure time or gas pressure. In this case, the pattern pitch and the etching resistance of the mask material can be taken into consideration. To achieve both the transfer properties of projections pattern and the suppression of diffusion, however, the thickness of the antidiffusion layer can be set to 0.5 to 6 nm. If the thickness is smaller than 0.5 nm, it becomes difficult to form a sufficient antidiffusion layer on the surface of the first mask layer, and the diffusion suppressing effect often becomes insufficient. If the thickness of the antidiffusion layer is larger than 6 nm, the aspect ratio of fine patterns increases, and pattern transfer often becomes difficult. It is also possible to properly change the substrate temperature in the oxygen or nitrogen ambient in order to control the thickness of the antidiffusion layer.

### Second Mask Layer Formation Step

Then, a second mask layer is formed on the antidiffusion layer. The second mask layer is made of a second metal material or mainly contains the second metal material. The second mask layer functions as a sub mask to be used to transfer projections pattern formed in an upper resist layer to the antidiffusion layer and first mask layer. For this purpose, it is possible to use, as this mask layer, a material capable of increasing the etching selectivity between the resist layer and first mask layer. The second metal material is different from the first metal material, and can be selected from a metal selected from Ni, Cu, Al, Mo, Ag, Pd, Au, Pt, Ti, Nb, and Ru, and an alloy, oxide, nitride, and carbide of the metal.

The antidiffusion layer is formed between the first and second mask layers, and reduces the mutual diffusion of the mask materials. In this case, the transfer properties of projections pattern from the second mask layer to the first mask layer improve.

Also, even when the mask layer thickness varies from one position to another in the medium, the in-plane variations of projections pattern can be reduced because the etching time can be adjusted within a relatively short range.

Furthermore, the second mask layer can effectively be thinned when forming the antidiffusion layer between the first and second mask layers. If no antidiffusion layer is formed, metal diffusion forms a metal compound in the first and second mask layers. Since the metal compound has a high etching resistance, the time of etching for exposing the surface of the first mask layer often prolongs. If the etching time prolongs, the second mask layer reduces, and the transfer properties of projections pattern to be obtained deteriorate. Accordingly, the thickness of the second mask layer must be increased in order to transfer projections pattern. This increases the aspect ratio, and makes pattern transfer difficult.

By contrast, the formation of the metal compound is little when the antidiffusion layer is formed, and it is relatively easy to expose the first mask layer by etching. In this case, the second mask layer can be formed without increasing its thickness.

The second mask layer can be formed by the same method as that for the first mask layer. Also, the thickness and surface roughness can be adjusted by changing parameters pertaining to deposition as described previously.

As described above, examples of the metal mask layer arrangement used in the embodiment are Ta/Ta₂O₅/Ni, Ta/Ta₂O₅/Al, Ta/Ta₂O₅/Cu, W/WO₃/Cr, W/WO/Cu, Hf/HfO/Mo, and Hf/HfO/Cu from the substrate side.

### Resist Layer Formation Step (Exposure Resist, Self-Organization, & Imprinting)

Then, a resist layer for forming projections pattern is formed on the first mask layer.

To form fine projections pattern on the resist layer, it is possible to apply an ultraviolet/electron beam exposure resist such as a novolak resin, a nanoimprinting resist that is cured by heat or ultraviolet irradiation, or a polymeric self-organized film.

The resist layer to be used to perform exposure or nanoimprinting can be formed by applying a precursor solution in the same manner as that for the above-described release layer. In this case, the thickness of the resist layer can be determined by taking account of the pattern pitch and the etching selectivity to the lower mask layer. Also, the resist layer need not be a single layer, and may also have a multilayered structure including resist layers different in, e.g., sensitivity. The type of resist material is not at all limited, and it is possible to use various resist materials such as a main chain scission resist, chemical amplification resist, and crosslinking resist.

It is also possible to form a self-organized film for projections pattern formation on the mask layer, and transfer the film to projections pattern. The self-organized film is typically a diblock copolymer having at least two different polymer chains. This diblock copolymer has a basic structure in which the ends of polymers having different chemical characteristics are covalently bonded like (block A)-(block B). The self-organized film is not limited to the diblock copolymer, and can also be a triblock copolymer or random copolymer.

Examples of the material forming the polymer block are polyethylene, polystyrene, polyisoprene, polybutadiene, polypropyrene, polydimethylsiloxane, polyvinylpyridine, polymethylmethacrylate, polybutylacrylate, polybutylmethacrylate, polydimethylacrylamide, polyethyleneoxide, polypropyreneoxide, polyacrylic acid, polyethylacrylic acid, polypropylacrylic acid, polymethacrylic acid, polylactide, polyvinylcarbazole, polyethyleneglycol, polycaprolactone, polyvinylidene fluoride, and polyacrylamide. The block copolymer can be formed by using two or more different polymers among these polymers.

The self-organized film using the block copolymer can be deposited on the metal mask layer by using spin coating or the like. In this case, a solvent by which polymers forming individual phases are compatible to each other is selected, and a solution prepared by dissolving the polymers in the solvent is used as a coating solution.

Practical examples selectable as the solvent are toluene, xylene, hexane, heptane, octane, ethyleneglycol monoethylether, ethyleneglycol monomethylether, ethyleneglycol monomethyletheracetate, propyleneglycol monomethyletheracetate, ethyleneglycol trimethylether, ethyl lactate, ethyl pyruvate, cyclohexanone, tetrahydrofuran, anisole, and diethyleneglycol triethylether.

The film thickness of the self-organized film can be changed by changing the concentration of the coating solution when using any of these solvents, or various parameters to be set when performing deposition.

When energy such as heat is applied to the self-organized film, the polymers cause phase separation and form a micro phase-separated structure inside the film. The micro phase-separated structure looks different in accordance with, e.g., the molecular weights of polymers forming the self-organized film. For example, island-like dots or cylindrical structures of polymer B are formed in a sea-like (matrix) pattern 7 of polymer A in a diblock copolymer. It is also possible to form a lamella structure in which polymers A and B are stacked, or a sphere structure in which the sea and island patterns are switched. The three-dimensional structure of the self-organized film can be formed by selectively removing one polymer phase in this pattern.

Energy is externally given when forming the micro phase-separated structure of the self-organized film. Energy can be given by, e.g., annealing using heat, or so-called solvent annealing by which a sample is exposed to a solvent ambient. When performing thermal annealing, the temperature can properly be set so as not to deteriorate the arrangement accuracy of the self-organized film, and so as not to decompose the polymeric layer that can be used as, e.g., the release layer. More specifically, the annealing temperature can be set lower than the order-disorder transition temperature of the self-organized film, and lower than the decomposition temperature of the polymeric release layer. If the annealing temperature is higher than the order-disorder transition temperature, phase separation of the self-organized film is disordered, and it is often impossible to transfer the projections pattern. Also, if the annealing temperature is higher than the decomposition temperature of the polymeric release layer, it often becomes difficult to transfer and remove the projections pattern.

Note that the upper portion of the mask layer can chemically be modified in order to improve the arrangement accuracy of the self-organized patterns. More specifically, the arrangement of the block copolymer can be improved by modifying, on the mask surface, any polymer phase forming the block copolymer. In this case, surface modification on a molecular level can be performed by polymer coating, annealing, and rinsing. Patterns having high in-plane uniformity can be obtained by coating this mask surface with the above-described block copolymer solution.

If it is difficult to transfer the projections pattern to the resist layer, a pattern transfer layer can be inserted between the first mask layer and resist layer. In this case, it is possible to select a material capable of securing the etching selectivity between the resist layer and metal mask layer.

### Resist Layer Patterning Step

Projections pattern is formed in the resist layer by etching.

First, exposure using an energy line can be performed to transfer the projections pattern to the resist layer.

As the exposure method, it is possible to apply, e.g., ultraviolet exposure or electron beam exposure by KrF or ArF, charged-particle beam exposure, and X-ray exposure. In addition to irradiation using an exposure mask, it is also possible to perform interference exposure, reduced projection exposure, and direct exposure.

First, an example of the formation of fine patterns by electron beam exposure will be explained. Examples of an electron beam lithography apparatus are an x-y lithography apparatus including stage moving mechanisms in biaxial directions perpendicular to an electron beam irradiation direction, and an x-θ lithography apparatus including a rotating mechanism in addition to a uniaxial moving mechanism. When using the x-y lithography apparatus, the stage can continuously be moved so as not to decrease the accuracy of connection between writing fields. When writing concentric patterns, the x-θ lithography apparatus that continuously rotates the stage can be used.

Also, when forming concentric patterns, deflection can be added to an electron beam in addition to the stage driving system. In this case, an information processor called a signal source is used in order to independently control deflection signals corresponding to writing patterns. The signal source can independently control the deflection pitch and deflection sensitivity of the electron beam, and the feed amount of the writing stage. By thus transmitting the deflection signal to the electron beam for each rotation, writing patterns can be formed into a concentric shape.

Then, the deposited resist film is patterned by exposing and developing the resist film. As an organic developer for the resist film, it is possible to use ester-based solvents such as methyl acetate, ethyl acetate, butyl acetate, amyl acetate, hexyl acetate, and octyl acetate, ketone-based solvents such as methyl ethyl ketone, methyl isobutyl ketone, and propyleneglycol monoethylacetate, aromatic solvents such as anisole, xylene, toluene, and tetralin, and alcohol-based solvents such as ethanol, methanol, and isopropyl alcohol. As an alkali developer, it is possible to use, e.g., tetramethylammoniumhydroxide and tetrapropylammoniumhydroxide.

Subsequently, the developer on the resist film is removed by wet rinsing. The rinsing solution is desirably compatible with the developer, and a typical example is isopropyl alcohol. In development and rinsing, desired pattern dimensions are obtained by adjusting the developing time, in addition to parameters pertaining to the solution, e.g., the temperature, viscosity, and mixing ratio.

Desired resist projections pattern is obtained by drying the rinsing solution on the resist film. As the drying method, it is possible to apply spin drying or supercritical drying, in addition to a method of directly blowing an inert gas such as N₂ against the sample, or heat drying by which the rinsing solution is volatilized by heating the substrate to a temperature higher than the boiling point of the rinsing solution. The projections pattern of the resist film can be obtained by electron beam exposure as described above.

Also, as a method of transferring the projections pattern to the resist layer, it is possible to form a self-organized layer as the resist layer, and form projections pattern by etching.

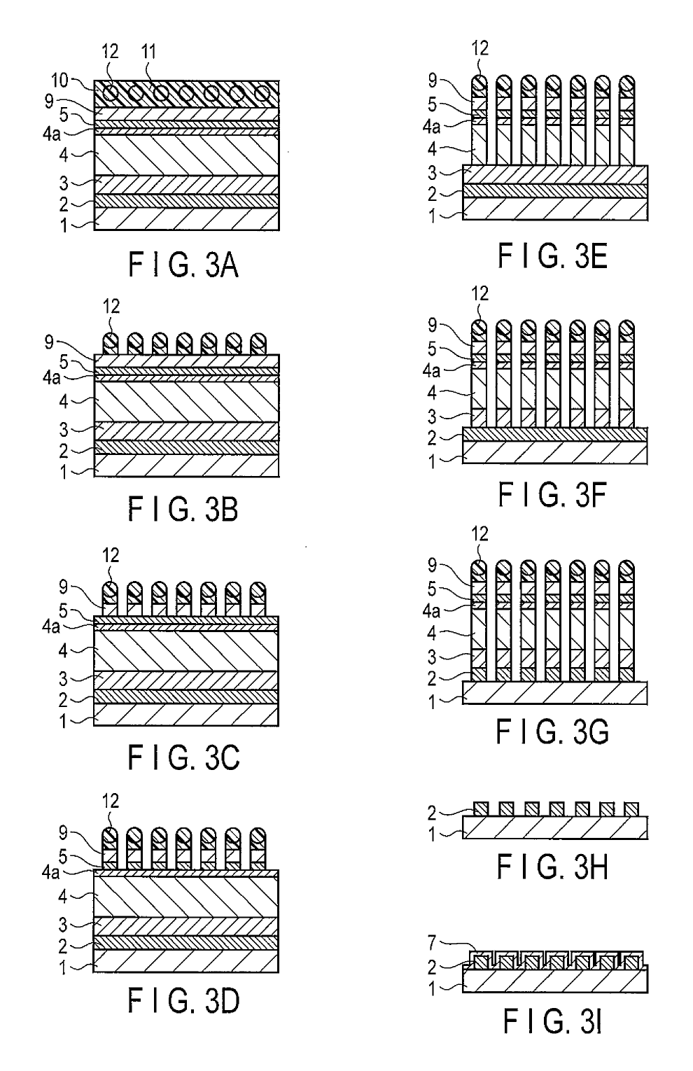

FIGS. 3A, 3B, 3C, 3D, 3E, 3F, 3G, 3H, and 3I are exemplary views showing other examples of the manufacturing steps of the magnetic recording medium according to the first embodiment.

As shown in FIGS. 3A, 3B, 3C, 3D, 3E, 3F, 3G, 3H, and 3I, these manufacturing steps are the same as those shown in FIGS. 1A, 1B, 1C, 1D, 1E, 1F, 1G, 1H, and 1I, except that a step (FIG. 3A) of forming a self-organized layer 10 having at least two different types of polymer chains as one type of a resist layer on the second mask layer 5 is performed, instead of the step (FIG. 1C) of forming the resist layer 6 on the second mask layer 5, and a step (FIG. 3B) of causing phase separation in the self-organized layer 10 and selectively removing one polymer layer is performed, instead of the step (FIG. 1D) of forming projections pattern in the resist layer 6.

The projections pattern is obtained by selectively removing a phase from a block copolymer. For example, in the diblock copolymer 10 made of a polystyrene-b-polydimethylsiloxane system, patterns of island-like polydimethylsiloxane 12 are formed in sea-like polystyrene 11 by properly setting the molecular weights. Dot-like, projections pattern 10 of polystyrene-b-polydimethylsiloxane are obtained by selectively removing one polymer layer, e.g., the sea-like polystyrene 11 by etching the diblock copolymer 10.

When forming the three-dimensional structure of the self-organized layer by etching, it is possible to apply wet etching by which a sample is dipped in a liquid chemical, and dry etching using a chemical reaction of active species. To precisely perform patterning in the thickness direction with respect to the width of fine patterns, it is possible to apply dry etching capable of suppressing etching in the widthwise direction.

In dry etching of a polymer phase, patterning can be performed while maintaining the etching selectivity by appropriately selecting active gas species. Generally, a material containing large amounts of C and H such as a benzene ring has a high etching resistance and hence can be used as a three-dimensional structure processing mask. The etching selectivity can be increased when using a material such as a block copolymer formed by appropriately combining polymers having different compositions, so the above-mentioned, projections pattern can be formed relatively easily. When using polystyrene-b-polydimethylsiloxane, for example, it is readily possible to remove polydimethylsiloxane by using a fluorine-based gas such as CF₄, and remove polystyrene by using O₂ gas. Accordingly, the etching selectivity can be secured between them.

If it is difficult to directly transfer the self-organized patterns to the lower metal mask, another transfer layer can be formed between the self-organized film and metal mask layer. For example, a mask material by which an etching gas capable of removing one layer of the block copolymer is usable as this transfer layer. When using polystyrene-b-polydimethylsiloxane, for example, polystyrene can be removed by O₂ etching, so it is possible to simultaneously etch the polymer and transfer layer by using only O₂ if a carbon film is used as the transfer layer. When the sea-like polymer is polydimethylsiloxane, etching is similarly possible by using CF₄ gas and Si as the transfer layer. By the process described above, the phase-separated patterns of the self-organized film can be processed into a three-dimensional shape.

If it is difficult to ensure the etching selectivity to the self-organized film, a pattern transfer layer can further be formed on the metal mask layer. It is possible to select a material by which the self-organized layer as an upper layer can be etched, and apply the material to the transfer layer in this case as well.

Furthermore, projections pattern formation by nanoimprinting lithography is also usable as the method of transferring the projections pattern to the resist layer.

Nanoimprinting is a method of transferring fine projections pattern formed on the surface of a stamper (a metal mold or stamp) by pressing the stamper against a transfer resist layer. This method can transfer resist patterns over a broad range at once, when compared to step-and-repeat ultraviolet exposure and electron beam exposure. Accordingly, the throughput can largely be improved by short-time processing.

The nanoimprinting stamper can be acquired from a substrate having fine projections pattern formed by lithography or the like, i.e., from a so-called master template. In many cases, the stamper is manufactured by electroforming (transfer by electroplating) for the fine patterns of the master template. As the substrate of the master template, it is possible to use Si, SiO₂, SiC, SiOC, Si₃N₄, or a semiconductor substrate in which an impurity such as B, Ga, In, or P is doped. Also, the three-dimensional shape of the substrate is not at all limited, and it is possible to use a circular, rectangular, or doughnut-like substrate. In addition, a substrate made of a conductive material can be used.

The mask layers are formed by sequentially stacking the first mask layer, antidiffusion layer, and second mask layer on this substrate as well. Stress produced in the interface between the metal layers distorts the projections pattern of the stamper obtained from the master template, and the in-plane flatness deteriorates. Since the antidiffusion layer has the effect of reducing this distortion produced between the metals, the flatness of the projections pattern of the obtained stamper improves. Note that in this case, the metal mask layers can be formed without performing the step of newly depositing an antidiffusion layer as described above. Since the stamper obtained from the master template is mechanically released from the substrate surface, it is possible to omit the release layer between the substrate and second mask layer.

Three-dimensional resist patterns are formed on the master template by forming the resist layer, performing lithography by electron beam exposure, and performing development and rinsing as described above. The resist projections pattern is then transferred to the metal mask layer or substrate by etching, thereby obtaining the master template having the projections pattern including the first mask layer/the antidiffusion layer containing the same element as that of the first mask layer/the second mask layer from the substrate side.

A stamper is manufactured by electroforming the projections pattern of the master template. Although various materials can be used as a plating metal, a method of manufacturing a Ni stamper will be explained as an example. First, to give conductivity to the projections pattern of the master template, a thin Ni film is deposited on the surface of the projections pattern. If defective conduction occurs during electroforming, plating growth is interrupted, and pattern missing occurs. Therefore, the thin Ni film can evenly be deposited on the upper surface and side surfaces of the projections pattern. Note that this electroforming may also be performed by electroplating or electroless plating. When using a conductive substrate, this thin Ni film need not be deposited because the projections pattern uniformly have high conductivity even when the antidiffusion layer is formed.

Subsequently, the master template is dipped in a Ni sulfamate bath, and an electric current is supplied to the bath, thereby performing electroforming. The film thickness after plating, i.e., the stamper thickness can be adjusted by changing, e.g., the supplied current value and plating time, in addition to the hydrogen ion concentration, temperature, and viscosity of the plating bath.

The stamper thus obtained is released from the substrate surface. If the resist layer remains on the three-dimensional surface of the stamper, the projections pattern can be exposed by removing the residue by etching. Finally, a nanoimprinting stamper is obtained by processing the stamper into a desired shape such as a circle or rectangle.

The projections pattern is transferred to the resist layer by using the obtained stamper. In this case, a duplicated stamper can be electroformed by using the stamper in place of the master template. Examples are a method of obtaining a Ni stamper from a Ni stamper, and a method of obtaining a resin stamper from a Ni stamper. The method of manufacturing a resin stamper will be explained as an example.

A resin stamper is manufactured by injection molding. First, the Ni stamper is loaded in an injection molding apparatus, and injection molding is performed by supplying a resin solution material to the projections pattern of the stamper. It is possible to apply, e.g., a cycloolefin polymer, polycarbonate, or polymethylmethacrylate as the resin solution material, and select a material having high removability to the imprinting resist. After molding, a resin stamper having a three-dimensional structure is obtained by releasing the resin stamper from the Ni stamper.

By using this resin stamper, the projections pattern is transferred to the resist layer on the metal mask layer. As the resist, it is possible to use a resist material such as a thermosetting resin or photosetting resin. For example, isobornyl acrylate, allyl methacrylate, or dipropyleneglycol diacrylate can be applied.

A sample including the magnetic recording layer and metal mask layer as described above is coated with any of these resist materials, thereby forming a resist layer. Then, the resin stamper having the projections pattern is imprinted on the resist layer. When the resist stamper is pressed against the resist during imprinting, the resist fluidizes to form projections pattern. The resist layer forming the projections pattern is cured by giving energy such as ultraviolet radiation to the resist layer, and the resin stamper is then released, thereby obtaining the projections pattern of the resist layer. To facilitate releasing the resin stamper, release processing using a silane coupling agent or the like can be performed on the resin stamper surface beforehand.

Since the resist material remains as a residue in the recesses of the resist layer, this residue is removed by etching. A polymer-based resist material generally has a low etching resistance to an O₂ etchant, so the residue is readily removable by O₂ etching. When an inorganic material is contained, an etchant can properly be changed so that the resist patterns remain. The projections pattern can be formed on the magnetic recording medium by nanoimprinting as described above.

### Mask Layer Patterning Step

Subsequently, the projections pattern of the resist layer are transferred to the first mask layer.

When processing the metal mask layer, it is possible to implement various layer arrangements and processing methods by combining a mask layer material and etching gas.

In the same way as for the above-described diblock copolymer, dry etching is applicable when performing micropatterning, such that etching in the thickness direction of the projections pattern is significant with respect to etching in the widthwise direction. A plasma required for dry etching can be generated by various methods such as capacitive coupling, inductive coupling, electron cyclotron resonance, and multi-frequency superposition coupling. Also, to adjust the pattern dimensions of the projections pattern, it is possible to set parameters such as the process gas pressure, gas flow rate, plasma input power, substrate temperature, chamber ambient, and ultimate vacuum degree.

When stacking metal materials in order to increase the etching gas selectivity, an etching gas can properly be selected. Examples of the etching gas are fluorine-based gases such as CF₄, C₂F₆, C₃F₆, C₃F₈, C₅F₈, C₄F₈, ClF₃, CCl₃F₅, C₂ClF₅, CCBrF₃, CHF₃, NF₃, and CH₂F₂, and chlorine-based gases such as Cl₂, BCl₃, CCl₄, and SiCl₄. Other various gases such as H₂, N₂, Br₂, HBr, NH₃, CO, C₂H₄, He, Ne, Ar, Kr, and Xe can also be applied. It is also possible to use a gas mixture obtained by mixing two or more types of these gases in order to adjust the etching rate or etching selectivity. Note that patterning can be performed by wet etching if it is possible to secure the etching selectivity and suppress etching in the widthwise direction. Similarly, physical etching such as ion milling can be performed.

As an example, a process using Ta as the first mask layer, Ta₂O₅ as the antidiffusion layer, and Al as the second mask layer will be explained.

First, the Al film can be processed by plasma etching using a gas mixture obtained by adding Ar gas to Cl₂ gas. If oxidation or the like is conspicuous on the surface of the second mask layer, the metal oxide layer can physically or chemically be removed.

Subsequently, the Ta₂O₅ antidiffusion layer and Ta as the first mask layer are processed by a fluorine-based plasma.

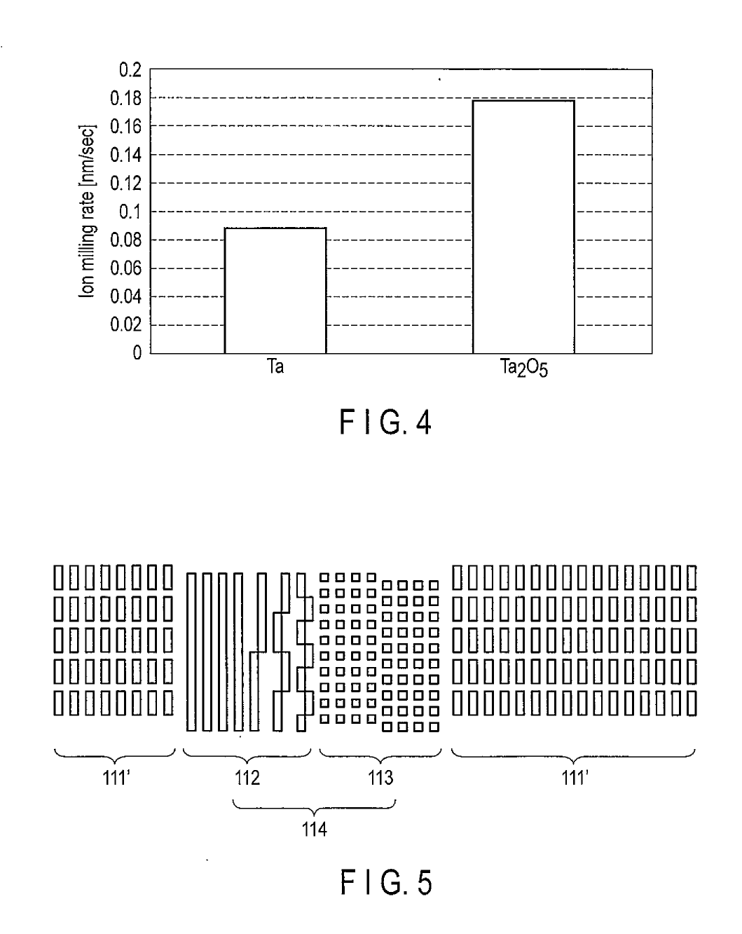

FIG. 4 is a graph showing the etching rates of the Ta₂O₅ film and Ta film in CF₄ plasma etching.

As shown in FIG. 4, the etching rate of the Ta₂O₅ film in CF₄ plasma etching is about twice as high as that of Ta. Accordingly, the antidiffusion layer and first mask can be processed at once. By contrast, the antidiffusion layer and first mask layer can be processed by different etching methods. The projections pattern of the resist layer can be transferred from the second mask to the antidiffusion layer and first mask layer.

### Release Layer Patterning Step

Subsequently, the projections pattern is transferred to the release layer.

The projections pattern can be transferred by etching in the same manner as for the metal mask layer. If wet etching is performed, however, the release layer dissolves, and the metal mask layer may collapse. Accordingly, pattern transfer can be performed by dry etching.

When performing dry etching by using a chemically active gas, it is important for the sake of the process to reduce modification on the surface of the polymeric release layer. If the surface is modified by etching, the removability to plasma or an etching solution decreases. For example, if dry etching using a fluorine-based gas is performed in the same manner as when removing a Si metal mask, the surface of the polymeric release layer is modified by the etching gas and becomes sparingly soluble in an organic solvent and water. This significantly deteriorates the removability of the mask. In this case, it is possible to properly select an etching gas, e.g., avoid the deterioration of the removability by performing dry etching using O₂ gas.

When patterning the release layer and magnetic recording layer, these layers can separately be etched, but they can also be processed at once by a method such as ion milling.

### Magnetic Recording Layer Patterning Step

Then, the projections pattern is transferred to the magnetic recording layer below the release layer.

To form magnetically isolated dots, a typical method is to form projections pattern by applying above-mentioned reactive ion etching or milling. In this case, patterning can be performed by a method of applying CO or NH₃ as an etching gas, or by ion milling using an inert gas such as Ar.

When transferring the three-dimensional structure to the magnetic recording layer by ion milling, it is necessary to suppress a byproduct that scatters toward the mask sidewalls by etching or milling, i.e., a so-called redeposition component. Since this redeposition component adheres around the projecting patterns, the projecting patterns increase the dimensions and fill the grooves. To obtain divided perpendicular magnetic recording layer patterns, therefore, it is important to reduce the redeposition component as soon as possible. Also, if the redeposition component produced when the perpendicular magnetic recording layer below the release layer is etched covers the side surfaces of the release layer, the release layer is not exposed to the release solution any longer, and the removability deteriorates. Accordingly, the redeposition component must be reduced.

When performing ion milling to the perpendicular magnetic recording layer, the redeposition component on the sidewalls can be reduced by changing the ion incident angle. Although an optimal incident angle changes in accordance with the mask height, redeposition can be suppressed within the range of 20° to 70°. Also, the incident angle can appropriately be changed during milling.

### Removing Step

Subsequently, the mask patterns on the magnetic recording layer are removed together with the release layer, thereby obtaining the magnetic recording layer having the projections pattern.

As described above, the release layer is made of a metal or polymeric material and hence can be removed by dry removal using plasma, or wet removal using an acid, alkali, or organic solvent.

In dry removal, the mask layers can be removed by using a plasma generated by a gas such as H₂, O₂, or N₂. In wet removal, it is possible to use various solutions, e.g., acid solutions such as a hydrogen peroxide solution and sulfuric acid, alkali solutions such as sodium hydroxide and potassium hydroxide, and organic solvents such as acetone and methanol. Furthermore, when performing wet removal, various methods are applicable by using the above-mentioned solutions. Examples are dipping, paddling, spinning, and vaporization. It is also possible to perform removal using scrubbing or ultrasonic waves.

### Protective Layer Formation Step

Finally, a carbon-based protective layer and a fluorine-based lubricating film (not shown) are deposited on the magnetic recording layer patterns having the three-dimensional structure, thereby obtaining a magnetic recording medium having the projections pattern.

As the carbon protective layer, a DLC film containing a large amount of sp³-bonded carbon can be used. Also, the film thickness of the protective layer can be set to 2 nm or more in order to maintain the coverage, and 10 nm or less in order to maintain the signal S/N. Furthermore, perfluoropolyether, alcohol fluoride, or fluorinated carboxylic acid can be used as a lubricant.

### Second Embodiment

An example of a magnetic recording medium manufacturing method according to the second embodiment will be explained below.

When using the magnetic recording medium manufacturing method according to the second embodiment, a patterned magnetic recording medium can be obtained following the same procedure as in the first embodiment, except for a step of forming a pattern transfer layer between a resist layer and first mask layer, and a step of transferring projections pattern to the transfer layer before a step of transferring the projections pattern to a second mask layer.

As described above, the pattern transfer layer capable of securing the etching selectivity between the resist layer and second mask layer is used. As an example, a medium using a self-organized layer as the resist layer and a transfer layer made of Si and C as the pattern transfer layer will be explained.

Generally, Si has a high etching resistance to an O₂ plasma and a low etching resistance to an F₂ plasma. By contrast, C has a high etching resistance to an F₂ plasma and a low etching resistance to an O₂ plasma. Accordingly, the projections pattern can be transferred to the transfer layer by performing processing in the same manner as that for a diblock copolymer. More specifically, a multilayered transfer layer containing C/Si/C is formed on the second mask layer, and self-organized patterns formed on the transfer layer are transferred by etching. It is possible to apply O₂ etching for the C layer, and CF₄ etching for the Si layer. Then, the projections pattern can be transferred by etching to Ta/Ta₂O₅/Al layers stacked from the substrate side as described previously.

FIG. 5 is a view showing examples of recording bit patterns in the circumferential direction of the magnetic recording medium.

As shown in FIG. 5, the projecting patterns of the magnetic recording layer are roughly classified into a recording bit area for recording data corresponding to 1 and 0 of digital signals, and a so-called servo area including preamble patterns serving as a magnetic head positioning signal, address patterns, and burst patterns. These patterns can be formed as in-plane patterns. Note that the patterns in the servo area shown in FIG. 5 need not have rectangular shapes. For example, all the servo patterns may also be replaced with dot-like patterns. Furthermore, not only the servo area but also the data area can entirely be formed by dot patterns. One-bit information can be formed by one magnetic dot or a plurality of magnetic dots.

### EXAMPLES

The embodiments will be explained in more detail below by way of their examples.

### Example 1

First, a magnetic recording layer was formed on a doughnut substrate having a diameter of 2.5 inches by DC sputtering. That is, the magnetic recording layer was obtained by sequentially depositing a 10-nm thick NiTa base layer/4-nm thick Pd base layer/20-nm thick Ru base layer/5-nm thick CoPt recording layer from the substrate side, and finally forming a 3-nm thick Pd protective layer, by setting the gas pressure at 0.7 Pa and the input power at 500 W.

Subsequently, a release layer was formed on the magnetic recording layer. An AlBN metal film was used as the release layer, and the layer was deposited to have a thickness of 5 nm by DC sputtering. This deposition was performed at an Ar gas pressure of 0.7 Pa and an input power of 500 W.

Subsequently, metal mask layers were formed on the release layer. That is, a 20-nm thick Ta film was selected as a first mask layer on the release layer, and deposited by sputtering at an Ar gas flow rate of 35 sccm, an Ar gas pressure of 0.3 Pa, and an input power of 200 W by using a facing target DC sputtering apparatus. In addition, O₂ gas was supplied at a flow rate of 40 sccm into the chamber after deposition, and oxidation was performed for 1 min, thereby forming a Ta oxide film as an antidiffusion layer on the surface of the Ta film. When observed by a cross-section TEM, the thickness of the antidiffusion layer was 3 nm.

Furthermore, an Al film was selected as a second metal, and deposited to have a thickness of 5 nm by DC sputtering.

Then, a main chain scission type electron beam positive resist for patterning was deposited. ZEP-520A available from ZEON was used as the electron beam resist, and a solution was prepared by diluting the resist by using anisole as a solvent at a weight ratio of 1:3. After that, the substrate was spin-coated with the solution by setting the rotational speed at 2,500 rpm. The sample was held at 180° C. and prebaked for 180 sec by using a vacuum hotplate, thereby curing the electron beam resist.

Then, patterns were written on the electron beam resist by using an electron beam lithography apparatus including a ZrO thermal-field-emission electron source, and a beam having an acceleration voltage of 100 kV and a beam diameter of 3 nm. The electron beam lithography apparatus was a so-called, x-θ lithography apparatus including a signal for forming writing patterns, and a unidirectional moving mechanism and rotating mechanism of a sample stage. When performing lithography on the sample, a signal for deflecting an electron beam was synchronized, and the stage was moved in the radial direction. In this example, latent images of dot/space patterns and line/space patterns having a pitch of 20 nm were formed on the electron beam resist by setting the writing linear speed at 0.15 m/s, the beam current value at 13 nA, and the radial-direction feed amount at 5 nm.

By developing the latent images, projections pattern having 10-nm diameter dots/10-nm spaces and 10-nm wide lines/10-nm wide spaces were obtained. That is, an organic developer containing 100% n-amyl acetate was used as a developer, and the electron beam resist was developed by dipping it in the developer for 20 sec. The resist was then rinsed as it was dipped in isopropylalcohol for 20 sec, and the sample surface was dried by direct blow of N₂.

Subsequently, the projections pattern of the resist layer were transferred to the second mask layer. In this pattern transfer, inductively coupled plasma etching using Cl₂ gas was applied. First, physical etching by Ar was performed to remove the surface oxide film on the Al film. That is, the surface oxide film was removed by performing etching for 5 sec at an Ar gas pressure of 0.2 Pa, a gas flow rate of 50 sccm, an input power of 100 W, and a bias power of 20 W. After that, the projections pattern was transferred to the Al film by Cl₂ etching. That is, the projections pattern of the resist layer were transferred to the Al mask layer by performing etching for 12 sec at a Cl₂ gas flow rate of 20 sccm, an input power of 200 W, and a bias power of 30 W.

Then, the patterns were transferred to the antidiffusion layer and first mask layer below the Al mask layer. That is, both Ta₂O₅ as the antidiffusion layer and Ta as the first mask can be removed by plasma etching using a fluorine-based gas. In this example, Ta mask patterns having a height of 20 nm were obtained by performing inductively coupled plasma etching using CF₄ gas for 25 sec at a flow rate of 20 sccm, a pressure of 0.1 Pa, an input power of 100 W, and a bias power of 30 W.

After that, the projections pattern was transferred to the release layer and magnetic recording layer. As described previously, projections pattern transfer to the release layer and magnetic recording layer can be performed by different etching steps, and can also be performed by the same step. In this example, Ar ion milling was applied. Milling was performed for 120 sec at an Ar ion acceleration voltage of 300 V, a gas flow rate of 3 sccm, and a process pressure of 0.1 Pa, thereby transferring the projections pattern to the 5-nm thick Al release layer, 3-nm thick Pd protective layer, and 5-nm thick CoPt magnetic film. Subsequently, wet etching for removing the mask patterns was performed. The AlBN metal film as the release layer can easily be removed by an alkali solution. In this example, the mask patterns were removed from the surface of the magnetic recording layer by dipping the sample in an aqueous sodium hydroxide solution having a weight percent concentration of 1% for 3 min.

Finally, a magnetic recording medium was obtained by depositing a 2-nm thick DLC film, and then forming a 1.5-nm thick perfluoropolyether-based lubricating film. The coercive force of the obtained magnetic recording medium was measured using a polar Kerr effect measurement device. The measurement portions were three points at a radius of 16 mm (on the inner circumference), a radius of 22 mm (on the middle circumference), and a radius of 28 mm (on the outer circumference) of the 2.5-inch disk. The coercive force of the medium was about 6.8 kOe, i.e., the medium had good read/write characteristics.

### Example 2

Example 2 was the same as Example 1 except that Ni was applied as a second mask layer instead of Al.

The Ni film was deposited by facing target DC sputtering. In this example, the film was deposited to have a thickness of 3 nm at an Ar gas pressure of 0.7 Pa and an input power of 500 W.

The projections pattern of an upper resist layer were transferred to this Ni film by etching it by Ar ion milling. That is, the projections pattern of the 3-nm thick Ni metal mask layer were obtained by performing milling for 45 sec at an Ar ion acceleration voltage of 300 V, a gas flow rate of 3 sccm, and a process pressure of 0.1 Pa.

After that, a magnetic recording medium having the projections pattern was obtained by performing pattern transfer and a removing step in the same manner as in Example 1. The coercive force of the obtained magnetic recording medium was 6.71 kOe when measured by a polar Kerr effect measurement device, indicating that the medium had good read/write characteristics.

### Example 3

Example 3 was the same as Example 1 except that Cu was applied as a second mask layer instead of Al.

The Cu film was deposited by facing target DC sputtering. In this example, the film was deposited to have a thickness of 2 nm at an Ar gas pressure of 0.7 Pa and an input power of 500 W.

The projections pattern of an upper resist layer were transferred to this Cu film by etching it by Ar ion milling. That is, the projections pattern of the 2-nm thick Cu metal mask layer were obtained by performing milling for 38 sec at an Ar ion acceleration voltage of 300 V, a gas flow rate of 3 sccm, and a process pressure of 0.1 Pa.

After that, a magnetic recording medium having the projections pattern was obtained by performing pattern transfer and a removing step in the same manner as in Example 1.

The coercive force of the obtained magnetic recording medium was 6.7 kOe when measured by a polar Kerr effect measurement device, indicating that the medium had good read/write characteristics.

### Example 4

Example 4 was the same as Example 1 except that Mo was applied as a second mask layer instead of Al.

The Mo film was deposited by facing target DC sputtering. In this example, the film was deposited to have a thickness of 5 nm at an Ar gas pressure of 0.7 Pa and an input power of 500 W.

The Mo film was then processed by plasma etching using CF₄ as an etchant. That is, the projections pattern of the 5-nm thick Mo metal mask layer is obtained by performing etching for 35 sec at a gas flow rate of 20 sccm, a gas pressure of 0.1 Pa, an input power of 100 W, and a bias power of 30 W.

After that, a magnetic recording medium having the projections pattern was obtained by performing pattern transfer and a removing step in the same manner as in Example 1.

The coercive force of the obtained magnetic recording medium was 7.1 kOe when measured by a polar Kerr effect measurement device, indicating that the medium had good read/write characteristics.

### Example 5

Example 5 was the same as Example 1 except that Ag was applied as a second mask layer instead of Al.

The Ag film was deposited by facing target DC sputtering. In this example, the film was deposited to have a thickness of 5 nm at an Ar gas pressure of 0.7 Pa and an input power of 500 W.

Then, the projections pattern of an upper resist layer were transferred to this Ag film by etching it by Ar ion milling. That is, the projections pattern of the 5-nm thick Ag metal mask layer were obtained by performing milling for 25 sec at an Ar ion acceleration voltage of 300 V, a gas flow rate of 3 sccm, and a process pressure of 0.1 Pa.

After that, a magnetic recording medium having the projectiqns pattern was obtained by performing pattern transfer and a removing step in the same manner as in Example 1.

The coercive force of the obtained magnetic recording medium was 6.5 kOe when measured by a polar Kerr effect measurement device, indicating that the medium had good read/write characteristics.

### Example 6

Example 6 was the same as Example 1 except that Pd was applied as a second mask layer instead of Al.

The Pd film was deposited by facing target DC sputtering. In this example, the film was deposited to have a thickness of 5 nm at an Ar gas pressure of 0.7 Pa and an input power of 500 W.

Then, the projections pattern of an upper resist layer were transferred to this Pd film by etching it by Ar ion milling. That is, the projections pattern of the 5-nm thick Pd metal mask layer was obtained by performing milling for 21 sec at an Ar ion acceleration voltage of 300 V, a gas flow rate of 3 sccm, and a process pressure of 0.1 Pa.

After that, a magnetic recording medium having the projections pattern was obtained by performing pattern transfer and a removing step in the same manner as in Example 1. The coercive force of the obtained magnetic recording medium was 6.7 kOe when measured by a polar Kerr effect measurement device, indicating that the medium had good read/write characteristics.

### Example 7

Example 7 was the same as Example 1 except that Au was applied as a second mask layer instead of Al.

The Au film was deposited by facing target DC sputtering. In this example, the film was deposited to have a thickness of 8 nm at an Ar gas pressure of 0.7 Pa and an input power of 500 W.

Then, the projections pattern of an upper resist layer was transferred to this Au film by etching it by Ar ion milling. That is, the projections pattern of the 8-nm thick Au metal mask layer were obtained by performing milling for 45 sec at an Ar ion acceleration voltage of 300 V, a gas flow rate of 3 sccm, and a process pressure of 0.1 Pa.

After that, a magnetic recording medium having the projections pattern was obtained by performing pattern transfer and a removing step in the same manner as in Example 1. The coercive force of the obtained magnetic recording medium was 6.8 kOe when measured by a polar Kerr effect measurement device, indicating that the medium had good read/write characteristics.

### Example 8

Example 8 was the same as Example 1 except that Pt was applied as a second mask layer instead of Al.

The Pt film was deposited by facing target DC sputtering. In this example, the film was deposited to have a thickness of 3 nm at an Ar gas pressure of 0.7 Pa and an input power of 500 W. Then, the projections pattern of an upper resist layer was transferred to this Pt film by etching it by Ar ion milling. That is, the projections pattern of the 3-nm thick Pt metal mask layer were obtained by performing milling for 25 sec at an Ar ion acceleration voltage of 300 V, a gas flow rate of 3 sccm, and a process pressure of 0.1 Pa.

After that, a magnetic recording medium having the projections pattern was obtained by performing pattern transfer and a removing step in the same manner as in Example 1. The coercive force of the obtained magnetic recording medium was 6.5 kOe when measured by a polar Kerr effect measurement device, indicating that the medium had good read/write characteristics.

### Example 9

Example 9 was the same as Example 1 except that Ti was applied as a second mask layer instead of Al.

The Ti film was deposited by facing target DC sputtering. In this example, the film was deposited to have a thickness of 1.5 nm at an Ar gas pressure of 0.7 Pa and an input power of 500 W.

Then, the projections pattern of an upper resist layer was transferred to this Ti film by etching it by Ar ion milling. That is, the projections pattern of the 1.5-nm thick Ti metal mask layer were obtained by performing milling for 28 sec at an Ar ion acceleration voltage of 300 V, a gas flow rate of 3 sccm, and a process pressure of 0.1 Pa.

After that, a magnetic recording medium having the projections pattern was obtained by performing pattern transfer and a removing step in the same manner as in Example 1. The coercive force of the obtained magnetic recording medium was 6.3 kOe when measured by a polar Kerr effect measurement device, indicating that the medium had good read/write characteristics.

### Example 10

Example 10 was the same as Example 1 except that Nb was applied as a second mask layer instead of Al.

The Nb film was deposited by facing target DC sputtering. In this example, the film was deposited to have a thickness of 5 nm at an Ar gas pressure of 0.7 Pa and an input power of 500 W. This Nb film was then processed by plasma etching using Cl₂ as an etchant. That is, the projections pattern of the 5-nm thick Nb metal mask layer were obtained by performing etching for 12 sec at a gas flow rate of 20 sccm, a gas pressure of 0.1 Pa, an input power of 100 W, and a bias power of 60 W.

After that, a magnetic recording medium having the projections pattern was obtained by performing pattern transfer and a removing step in the same manner as in Example 1. The coercive force of the obtained magnetic recording medium was 6.5 kOe when measured by a polar Kerr effect measurement device, indicating that the medium had good read/write characteristics.

### Example 11

Example 11 was the same as Example 1 except that Ru was applied as a second mask layer instead of Al.

The Ru film was deposited by facing target DC sputtering. In this example, the film was deposited to have a thickness of 2 nm at an Ar gas pressure of 0.7 Pa and an input power of 500 W.

This Ru film was then processed by plasma etching using O₂ as an etchant. That is, the projections pattern of the 2-nm thick Ru metal mask layer were obtained by performing etching for 27 sec at a gas flow rate of 20 sccm, a gas pressure of 0.1 Pa, an input power of 100 W, and a bias power of 80 W.

After that, a magnetic recording medium having the projections pattern was obtained by performing pattern transfer and a removing step in the same manner as in Example 1. The coercive force of the obtained magnetic recording medium was 6.4 kOe when measured by a polar Kerr effect measurement device, indicating that the medium had good read/write characteristics.

### Example 12

Example 12 was the same as Example 1 except that Si was applied as a first mask layer instead of Ta.

The Si film was deposited by facing target DC sputtering. In this example, the film was deposited to have a thickness of 20 nm at an Ar gas pressure of 0.7 Pa and an input power of 500 W. Also, a 5-nm thick Al film was deposited as in Example 1.

The Si film was then processed by plasma etching using CF₄ as an etchant. That is, the projections pattern of the 20-nm thick Si metal mask layer were obtained by performing etching for 58 sec at a gas flow rate of 20 sccm, a gas pressure of 0.1 Pa, an input power of 100 W, and a bias power of 30 W.

After that, a magnetic recording medium having the projections pattern was obtained by performing pattern transfer and a removing step in the same manner as in Example 1. The coercive force of the obtained magnetic recording medium was 6.45 kOe when measured by a polar Kerr effect measurement device, indicating that the medium had good read/write characteristics.

### Example 13

Example 13 was the same as Example 1 except that Ge was applied as a first mask layer instead of Ta.

The Ge film was deposited by facing target DC sputtering. In this example, the film was deposited to have a thickness of 20 nm at an Ar gas pressure of 0.7 Pa and an input power of 500 W. Also, a 5-nm thick Al film was deposited as in Example 1.

The Ge film was then processed by plasma etching using CF₄ as an etchant. That is, the projections pattern of the 20-nm thick Ge metal mask layer were obtained by performing etching for 19 sec at a gas flow rate of 20 sccm, a gas pressure of 0.1 Pa, an input power of 100 W, and a bias power of 30 W.

After that, a magnetic recording medium having the projections pattern was obtained by performing pattern transfer and a removing step in the same manner as in Example 1. The coercive force of the obtained magnetic recording medium was 6.1 kOe when measured by a polar Kerr effect measurement device, indicating that the medium had good read/write characteristics.

### Example 14

Example 14 was the same as Example 1 except that W was applied as a first mask layer instead of Ta.

The W film was deposited by facing target DC sputtering. In this example, the film was deposited to have a thickness of 20 nm at an Ar gas pressure of 0.7 Pa and an input power of 500 W. Also, a 5-nm thick Al film was deposited as in Example 1.

The W film was then processed by plasma etching using CF₄ as an etchant. That is, the projections pattern of the 20-nm thick W metal mask layer was obtained by performing etching for 62 sec at a gas flow rate of 20 sccm, a gas pressure of 0.1 Pa, an input power of 100 W, and a bias power of 30 W.

After that, a magnetic recording medium having the projections pattern was obtained by performing pattern transfer and a removing step in the same manner as in Example 1. The coercive force of the obtained magnetic recording medium was 6.9 kOe when measured by a polar Kerr effect measurement device, indicating that the medium had good read/write characteristics.

### Example 15

Example 15 was the same as Example 1 except that Hf was applied as a first mask layer instead of Ta.

The Hf film was deposited by facing target DC sputtering. In this example, the film was deposited to have a thickness of 20 nm at an Ar gas pressure of 0.7 Pa and an input power of 500 W. Also, a 5-nm thick Al film was deposited as in Example 1.

The Hf film was then processed by plasma etching using Cl₂ as an etchant. That is, the projections pattern of the 20-nm thick Hf metal mask layer was obtained by performing etching for 36 sec at a gas flow rate of 20 sccm, a gas pressure of 0.1 Pa, an input power of 100 W, and a bias power of 40 W.

After that, a magnetic recording medium having the projections pattern was obtained by performing pattern transfer and a removing step in the same manner as in Example 1. The coercive force of the obtained magnetic recording medium was 6.4 kOe when measured by a polar Kerr effect measurement device, indicating that the medium had good read/write characteristics.

### Example 16

Example 16 was the same as Example 1 except that Zr was applied as a first mask layer instead of Ta.

The Zr film was deposited by facing target DC sputtering. In this example, the film was deposited to have a thickness of 20 nm at an Ar gas pressure of 0.7 Pa and an input power of 500 W. Also, a 5-nm thick Al film was deposited as in Example 1.

The Zr film was then processed by plasma etching using Cl₂ as an etchant. That is, the projections pattern of the 20-nm thick Hf metal mask layer was obtained by performing etching for 23 sec at a gas flow rate of 20 sccm, a gas pressure of 0.1 Pa, an input power of 100 W, and a bias power of 40 W.

After that, a magnetic recording medium having the projections pattern was obtained by performing pattern transfer and a removing step in the same manner as in Example 1. The coercive force of the obtained magnetic recording medium was 6.5 kOe when measured by a polar Kerr effect measurement device, indicating that the medium had good read/write characteristics.

### Example 17

Example 17 was the same as Example 1 except that an NiAl alloy was applied as a second mask layer instead of Al.

The NiAl film was deposited by facing target DC sputtering. In this example, the film was deposited to have a thickness of 5 nm at an Ar gas pressure of 0.7 Pa and an input power of 500 W. Also, a 20-nm thick Ta film was deposited as in Example 1.

The NiAl film was then processed by plasma etching using Cl₂ as an etchant. That is, the projections pattern of the 5-nm thick NiAl metal mask layer was obtained by performing etching for 35 sec at a gas flow rate of 20 sccm, a gas pressure of 0.1 Pa, an input power of 100 W, and a bias power of 40 W.

After that, a magnetic recording medium having the projections pattern was obtained by performing pattern transfer and a removing step in the same manner as in Example 1. The coercive force of the obtained magnetic recording medium was 5.7 kOe when measured by a polar Kerr effect measurement device, indicating that the medium had good read/write characteristics.

### Example 18

Example 18 was the same as Example 1 except that Al₂O₃ was applied as a second mask layer instead of Al.

The Al₂O₃ film was deposited by facing target DC sputtering. In this example, the film was deposited to have a thickness of 5 nm at an Ar gas pressure of 0.7 Pa and an input power of 500 W. Also, a 20-nm thick Ta film was deposited as in Example 1.

Then, the projections pattern of an upper resist layer was transferred to the Al₂O₃ film by etching it by Ar ion milling. That is, the projections pattern of the 5-nm thick Al₂O₃ metal mask layer was obtained by performing milling for 7 sec at an Ar ion acceleration voltage of 300 V, a gas flow rate of 3 sccm, and a process pressure of 0.1 Pa.

After that, a magnetic recording medium having the projections pattern was obtained by performing pattern transfer and a removing step in the same manner as in Example 1. The coercive force of the obtained magnetic recording medium was 5.1 kOe when measured by a polar Kerr effect measurement device, indicating that the medium had good read/write characteristics.

### Example 19

Example 19 was the same as Example 1 except that AlN was applied as a second mask layer instead of Al.

The AlN film was deposited by facing target DC sputtering. In this example, the film was deposited to have a thickness of 3 nm at an Ar gas pressure of 0.7 Pa and an input power of 500 W. Also, a 20-nm thick Ta film was deposited as in Example 1.

The AlN film was then processed by plasma etching using Cl₂ as an etchant. That is, the projections pattern of the 3-nm thick AlN metal mask layer were obtained by performing etching for 19 sec at a gas flow rate of 20 sccm, a gas pressure of 0.1 Pa, an input power of 100 W, and a bias power of 40 W.

After that, a magnetic recording medium having the projections pattern was obtained by performing pattern transfer and a removing step in the same manner as in Example 1. The coercive force of the obtained magnetic recording medium was 5.3 kOe when measured by a polar Kerr effect measurement device, indicating that the medium had good read/write characteristics.

### Example 20

Example 20 was the same as Example 1 except that AlC was applied as a second mask layer instead of Al.

The AlC film was deposited by facing target DC sputtering. In this example, the film was deposited to have a thickness of 2 nm at an Ar gas pressure of 0.7 Pa and an input power of 500 W. Also, a 20-nm thick Ta film was deposited as in Example 1.

The AlC film was then processed by plasma etching using Cl₂ and O₂ as etchants. That is, the projections pattern of the 2-nm thick AlC metal mask layer was obtained by performing etching for 14 sec at a Cl₂ gas flow rate of 20 sccm, an O₂ gas flow rate of 20 sccm, a gas pressure of 0.1 Pa, an input power of 100 W, and a bias power of 30 W.

After that, a magnetic recording medium having the projections pattern was obtained by performing pattern transfer and a removing step in the same manner as in Example 1. The coercive force of the obtained magnetic recording medium was 5.2 kOe when measured by a polar Kerr effect measurement device, indicating that the medium had good read/write characteristics.

### Example 21

Example 21 was the same as Example 1 except that the thickness of an antidiffusion layer was increased to 6 nm. When forming the antidiffusion layer on the Ta surface, the surface of a mask layer was exposed to an O₂ gas ambient at a flow rate of 50 sccm for 5 min, thereby forming a 6-nm thick antidiffusion layer.

After that, a magnetic recording medium having projections pattern was obtained by performing pattern transfer and a removing step in the same manner as in Example 1. The coercive force of the obtained magnetic recording medium was 6.4 kOe when measured by a polar Kerr effect measurement device, indicating that the medium had good read/write characteristics.

### Example 22

Example 22 was the same as Example 1 except that a micro phase-separated structure was formed by using a self-organized film instead of performing patterning by electron beam lithography by using ZEP-520A as a resist layer, etching was performed based on the micro phase-separated patterns, and a transfer layer made of C and Si was formed between the self-organized film and a second mask layer in order to increase the precision of projections pattern transfer of the self-organized film.

This transfer layer was formed on the second mask layer by DC sputtering. In this example, 20-nm thick C/5-nm thick Si/3-nm thick C were deposited at an Ar gas pressure of 0.7 Pa and an input power of 500 W.

Subsequently, the transfer layer was coated with a block copolymer solution. As the block copolymer solution, a solution prepared by dissolving a block copolymer containing polystyrene and polydimethylsiloxane in a coating solvent was used. The molecular weights of polystyrene and polydimethylsiloxane were respectively 11,700 and 2,900. In addition, a polymer solution was prepared at a weight percent concentration of 1.5% by using anisole as a solvent. The mask was spin-coated with this solution at a rotational speed of 5,000 rpm, thereby depositing a single-layered, self-organized film. Furthermore, thermal annealing was performed to cause micro phase separation of polydimethylsiloxane dot patterns and a polystyrene matrix inside the self-organized film. This thermal annealing was performed at 170° C. for 12 hrs in a reduced-pressure ambient at an internal pressure of 0.2 Pa by using a vacuum heating furnace, thereby forming a micro phase-separated structure having a pitch dot of 20 nm inside the self-organized film.

Subsequently, projections pattern were formed by etching based on the phase-separated patterns. This etching was performed by inductively coupled plasma reactive ion etching. The process gas was set at 0.1 Pa, and the gas flow rate was set at 5 sccm. First, to remove polydimethylsiloxane in the surface layer of the self-organized film, etching was performed for 7 sec by using CF₄ gas as an etchant at an antenna power of 50 W and a bias power of 5 W. Then, to transfer the projections pattern to the polystyrene matrix and the C transfer layer below the polymer layer, etching was performed for 110 sec by using O₂ gas as an etchant at an antenna power of 100 W and a bias power of 5 W. Since the O₂ etchant for removing polystyrene also etched the C mask as a lower layer, etching stopped at the Si metal layer as a stopper layer. Subsequently, the projections pattern was transferred to the lower C/Si layer by plasma etching using the CF₄ etchant and O₂ etchant, thereby obtaining the projections pattern of the self-organized film on the Al metal mask.

After that, a magnetic recording medium having the projections pattern was obtained by performing pattern transfer and a removing step in the same manner as in Example 1. The coercive force of the obtained magnetic recording medium was 6.7 kOe when measured by a polar Kerr effect measurement device, indicating that the medium had good read/write characteristics.

### Example 23

Example 23 was the same as Example 1 except that projections pattern was formed by using a nanoimprinting resist as a resist layer and using a nanoimprinting stamper, instead of forming projections pattern by electron beam lithography by using ZEP-520A as a resist layer.

First, to manufacture a nanoimprinting stamper, a master template was manufactured. That is, a versatile 6-inch Si wafer was used as a substrate, and a Ta metal mask layer/Ta₂O₅ antidiffusion layer/Al metal mask layer were formed in the same manner as in Example 1. Then, an electron beam resist layer was formed, and 20-nm pitch dot patterns were formed by electron beam lithography.

A nanoimprinting stamper was manufactured using this master template. First, to perform conduction processing on projections pattern, a Ni film was deposited by DC sputtering. That is, the projections pattern was coated with a 5-nm thick Ni film at an ultimate vacuum degree of 8.0×10⁻⁴ Pa, an Ar gas pressure of 1.0 Pa, and a DC input power of 200 W. As the conductive film formation method, it is also possible to use a Ni—P alloy or Ni—B alloy formed by deposition or electroless plating, instead of sputtering. Furthermore, to facilitate releasing the stamper, the surface of the conductive film may also be oxidized. Subsequently, a Ni film was formed along the projections pattern by electroforming. A high-concentration nickel sulfamate plating solution (NS-169) available from Showa Chemical was used as an electroforming solution. A 300-μm thick Ni stamper was manufactured at a solution temperature of 55° C., a pH of 3.8 to 4.0, and a supplied current density of 20 A/dm² as electroforming conditions by using 600 g/L of nickel sulfamate, 40 g/L of boric acid, and 0.15 g/L of a sodium lauryl sulfate surfactant. A nanoimprinting stamper having projections pattern can be obtained by releasing this Ni stamper from the master template. If a residue or particles exist on the stamper three-dimensional structure after release, the stamper can be cleaned by removing the residue or particles by performing etching as needed. Note that the patterns of the master template have the metal/antidiffusion layer/metal structure described in Example 1. Since the patterns have little distortion and cause little pattern loss upon stamper release, the patterns can repetitively be used when duplicating a stamper. In addition, the distortion is smaller than that of projections pattern made of only a metal, and this facilitates releasing the stamper from the master template. Finally, a Ni stamper was obtained by punching the electroformed Ni plate into a 2.5-inch circular disk. A resin stamper was duplicated by injection molding by using this Ni stamper. A cyclic olefin polymer (ZEONOR 1060R) available from ZEON was used as a resin material.

Projections pattern was formed in the resist layer by using the resin stamper obtained as described above. First, a sample was spin-coated with a 40-nm thick ultraviolet-curing resist as a resist layer. Then, the above-mentioned resin stamper was imprinted on the resist layer, and the resist layer was cured by irradiation with ultraviolet light (ultraviolet light was emitted while the ultraviolet-curing resin layer was pressed by the resin stamper). Desired 20-nm pitch dot patterns were obtained by releasing the resin stamper from the cured resist layer.

A resist residue formed in the grooves of the projections pattern by imprinting was removed by etching. This removal of the resist residue was done by plasma etching using an O₂ etchant. That is, the resist residue was removed by performing etching for 8 sec at an O₂ gas flow rate of 20 sccm, a pressure of 0.1 Pa, an input power of 100 W, and a bias power of 20 W. The projections pattern of the resist layer was thus formed on the sample including the magnetic recording layer.

After that, a magnetic recording medium having the projections pattern was obtained by performing pattern transfer and a removing step in the same manner as in Example 1. The coercive force of the obtained magnetic recording medium was 6.8 kOe when measured by a polar Kerr effect measurement device, indicating that the medium had good read/write characteristics.

### Example 24

Example 24 was the same as Example 1 except that the thickness of an antidiffusion layer was increased to 10 nm.

When forming the antidiffusion layer on the Ta surface, the surface of a mask layer was exposed to an O₂ gas ambient at a flow rate of 50 sccm for 20 min, thereby forming a 10-nm thick antidiffusion layer.

After that, a magnetic recording medium having projections pattern was obtained by performing pattern transfer and a removing step in the same manner as in Example 1. Since the thickness of the antidiffusion layer increased, the net Ta main mask thickness decreased, and the Ar ion milling resistance decreased. The coercive force of the obtained magnetic recording medium was 4.9 kOe when measured by a polar Kerr effect measurement device.

### Example 25

Example 25 was the same as Example 1 except that Ta₂O₅ was used as a first metal main mask instead of Ta.

The Ta₂O₅ film was deposited by facing target DC sputtering. In this example, the film was deposited to have a thickness of 20 nm at an Ar gas pressure of 0.7 Pa and an input power of 500 W. Also, a 5-nm thick Al film was deposited as in Example 1.

The Ta₂O₅ film was then processed by plasma etching using CF₄ as an etchant. That is, the projections pattern of the 20-nm thick Ta₂O₅ metal mask layer was obtained by performing etching for 90 sec at a CF₄ gas flow rate of 20 sccm, a gas pressure of 0.1 Pa, an input power of 100 W, and a bias power of 30 W.

After that, a magnetic recording medium having the projections pattern was obtained by performing pattern transfer and a removing step in the same manner as in Example 1. The coercive force of the obtained magnetic recording medium was 4.2 kOe when measured by a polar Kerr effect measurement device. When the surface of the sample was observed with a metal microscope, dust particles produced by the deposition of Ta₂O₅ were found, and the in-plane uniformity and flatness of the patterns deteriorated. This increased the in-plane variation in magnetic characteristics.

### Example 26

Example 26 was the same as Example 1 except that an antidiffusion layer was formed on a first metal mask layer by exposure to a nitrogen atmosphere. After a Ta film as the first metal mask was deposited, N₂ gas was supplied to a vacuum chamber, and the substrate temperature was raised to 300° C. and held for 3 min in order to promote nitriding on the surface, thereby forming a 5-nm thick TaN antidiffusion layer. This antidiffusion layer can easily be removed by Ar ion milling in the same manner as in Example 1.

After that, a magnetic recording medium having projections pattern was obtained by performing pattern transfer and a removing step in the same manner as in Example 1. The coercive force of the obtained magnetic recording medium was 6.1 kOe when measured by a polar Kerr effect measurement device, indicating that the medium had good read/write characteristics.

### Example 27

Example 27 was the same as Example 1 except that Al was used as a first metal main mask, and a second sub mask was replaced with Ta. The Al film thickness was set to 30 nm, and the Ta mask thickness was set to 5 nm. Also, the Al film was formed by plasma etching using Cl₂ gas, and the Ta film was formed by plasma etching using CF₄ gas.

After that, a magnetic recording medium having projections pattern was obtained by performing pattern transfer and a removing step in the same manner as in Example 1. The coercive force of the obtained magnetic recording medium was 4.9 kOe when measured by a polar Kerr effect measurement device.

### Comparative Example 1

Comparative Example 1 was the same as Example 1 except that first and second metal mask layers were made of the same material. In this example, the first and second mask layers were formed by using Ta. An antidiffusion layer was formed on the first Ta film. In this example, the antidiffusion layer was formed by exposure to O₂ gas. Also, the mask layers were processed by plasma etching using CF₄ gas in the same manner as in Example 1.

After that, a magnetic recording medium having projections pattern was obtained by performing pattern transfer and a removing step in the same manner as in Example 1. The coercive force of the obtained magnetic recording medium was 3.1 kOe when measured by a polar Kerr effect measurement device. When pattern observation was performed with a cross-section TEM, it was found that the second metal mask layer and the upper portion of the first metal mask layer significantly reduced.

### Comparative Example 2

Comparative Example 2 was the same as Example 1 except that no antidiffusion layer was formed between first and second metal mask layers. A Ta film was used as the first mask layer, and an Al film as the second metal mask layer was directly formed on the Ta film without forming any antidiffusion layer.

After that, a magnetic recording medium having projections pattern was obtained by performing pattern transfer and a removing step in the same manner as in Example 1. The coercive force of the obtained magnetic recording medium was 2.4 kOe when measured by a polar Kerr effect measurement device. When pattern observation was performed with a cross-section TEM, it was found that the second metal mask layer and the upper portion of the first metal mask layer significantly reduced. In addition, an Al—Ta intermetallic compound was formed in the interface between the first and second metal mask layers, and deteriorated the pattern transfer properties. Also, the variation in coercive force of the medium increased with increasing size dispersion of the projections pattern.

TABLE 1

| | | | | | Coercive force (kOe) | | | |
|---|---|---|---|---|---|---|---|---|
| | | First | Antidiffusion | Second | Inner | Middle | Outer | Total |
| | | metal | layer | metal | circumference | circumference | circumference | evaluation |
| Example | 1 | Ta | Oxide | Al | 6.8 | 6.7 | 6.73 | ◯ |
| | 2 | Ta | Oxide | Ni | 6.71 | 6.8 | 6.65 | ◯ |
| | 3 | Ta | Oxide | Cu | 6.7 | 6.8 | 6.7 | ◯ |
| | 4 | Ta | Oxide | Mo | 7.1 | 6.9 | 6.9 | ◯ |
| | 5 | Ta | Oxide | Ag | 6.5 | 6.4 | 6.2 | ◯ |
| | 6 | Ta | Oxide | Pd | 6.7 | 6.8 | 6.7 | ◯ |
| | 7 | Ta | Oxide | Au | 6.8 | 6.6 | 6.8 | ◯ |
| | 8 | Ta | Oxide | Pt | 6.5 | 6.5 | 6.2 | ◯ |
| | 9 | Ta | Oxide | Ti | 6.3 | 6.4 | 6.2 | ◯ |
| | 10 | Ta | Oxide | Nb | 6.5 | 6.7 | 6.2 | ◯ |
| | 11 | Ta | Oxide | Ru | 6.4 | 6.5 | 6.6 | ◯ |
| | 12 | Si | Oxide | Al | 6.45 | 6.3 | 6.1 | ◯ |
| | 13 | Ge | Oxide | Al | 6.1 | 6.2 | 6.0 | ◯ |
| | 14 | W | Oxide | Al | 6.9 | 6.8 | 6.4 | ◯ |
| | 15 | Hf | Oxide | Al | 6.4 | 6.2 | 6.2 | ◯ |
| | 16 | Zr | Oxide | Al | 6.5 | 6.4 | 6.2 | ◯ |
| | 17 | Ta | Oxide | NiAl | 5.7 | 5.2 | 4.9 | Δ |
| | 18 | Ta | Oxide | Al₂O₃ | 5.1 | 5.0 | 5.2 | Δ |
| | 19 | Ta | Oxide | AlN | 5.3 | 4.9 | 4.92 | Δ |
| | 20 | Ta | Oxide | AlC | 5.2 | 5.3 | 4.9 | Δ |
| | 21 | Ta | Oxide | Al | 6.4 | 6.5 | 6.8 | ◯ |
| | 22 | Ta | Oxide | Al | 6.7 | 6.2 | 6.8 | ◯ |
| | 23 | Ta | Oxide | Al | 6.8 | 6.8 | 6.5 | ◯ |
| | 24 | Ta | Oxide | Al | 4.9 | 4.8 | 5.1 | Δ |
| | 25 | Ta | Oxide | Al | 4.2 | 4.4 | 4.7 | Δ |
| | 26 | Ta | Nitride | Al | 6.1 | 6.1 | 6.3 | ◯ |
| | 27 | Al | Oxide | Ta | 4.9 | 4.5 | 5.2 | Δ |
| Comparative | 1 | Ta | Oxide | Ta | 3.1 | 2.9 | 2.1 | X |
| Example | 2 | Ta | None | Al | 2.4 | 3.5 | 2.8 | X |

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A magnetic recording medium manufacturing method comprising:
forming a magnetic recording layer on a substrate;
forming a release layer on the magnetic recording layer;
forming a first mask layer comprising a first metal material on the release layer;
modifying a surface region of the first mask layer by exposing the first mask layer to an oxygen ambient or a nitrogen ambient, thereby forming an antidiffusion layer containing an oxide or a nitride of the first metal material;
forming a second mask layer comprising a second metal material different from the first metal material on the antidiffusion layer;
forming a resist layer on the second mask layer;
forming a projections pattern by patterning the resist layer;
transferring the projections pattern to the second mask layer;
transferring the projections pattern to the antidiffusion layer;
transferring the projections pattern to the first mask layer;
transferring the projections pattern to the release layer;
transferring the projections pattern to the magnetic recording layer; and
removing the release layer, and also removing layers remaining on the release layer.

2. The method according to claim 1, wherein the first metal material is a material selected from the group consisting of tantalum, silicon, germanium, tungsten, hafnium, zirconium, and alloys thereof.

3. The method according to claim 1, wherein the second metal material is a material selected from the group consisting of nickel, copper, aluminum, molybdenum, silver, palladium, gold, platinum, titanium, niobium, ruthenium, alloys thereof, oxides thereof, nitrides thereof, and carbides thereof.

4. The method according to claim 1, wherein the antidiffusion layer has a thickness in the range of about 0.5 nm to about 6 nm.

5. The method according to claim 1, wherein the forming the antidiffusion layer comprises supplying to a vacuum chamber a gas comprising oxygen or nitrogen.

6. The method according to claim 1, wherein the resist layer is a self-organized film comprising at least two different types of polymer chains.

7. The method according to claim 1, wherein the projections pattern of the resist film is formed by nanoimprinting.

8. The method according to claim 1, further comprising forming between the second mask layer and the resist layer, a pattern transfer layer comprising carbon.

9. A magnetic recording medium manufactured by a magnetic recording medium manufacturing method comprising:
forming a magnetic recording layer on a substrate;
forming a release layer on the magnetic recording layer;
forming a first mask layer containing a first metal material on the release layer;
modifying a surface region of the first mask layer by exposing the first mask layer to an oxygen ambient or a nitrogen ambient, thereby forming an antidiffusion layer comprising an oxide or a nitride of the first metal material;
forming a second mask layer containing a second metal material different from the first metal material on the antidiffusion layer;
forming a resist layer on the second mask layer;
forming a projections pattern by patterning the resist layer;
transferring the projections pattern to the second mask layer;
transferring the projections pattern to the antidiffusion layer;
transferring the projections pattern to the first mask layer;
transferring the projections pattern to the release layer;
transferring the projections pattern to the magnetic recording layer; and
removing the release layer, and also removing layers remaining on the release layer.

10. The medium according to claim 9, wherein the first metal material is a material selected from the group consisting of tantalum, silicon, germanium, tungsten, hafnium, zirconium, and alloys thereof.

11. The medium according to claim 9, wherein the second metal material is a material selected from the group consisting of nickel, copper, aluminum, molybdenum, silver, palladium, gold, platinum, titanium, niobium, ruthenium, alloys thereof, oxides thereof, nitrides thereof, and carbides thereof.

12. The medium according to claim 9, wherein the antidiffusion layer has a thickness in the range of about 0.5 nm to about 6 nm.

13. The medium according to claim 9, wherein the forming the antidiffusion layer comprises supplying to a vacuum chamber a gas comprising oxygen or nitrogen.

14. The medium according to claim 9, wherein the resist layer is a self-organized film comprising at least two different types of polymer chains.

15. The medium according to claim 9, wherein the projections pattern of the resist film is formed by nanoimprinting.

16. The medium according to claim 9, wherein a pattern transfer layer comprising carbon is formed between the second mask layer and the resist layer.
